(19) United States
(12) Patent Application Publication
(10) Pub. No.: US 2025/0062373 A1
(43) Pub. Date: Feb. 20, 2025

(54) A CONTROL UNIT

(71) Applicant: VOLVO TRUCK CORPORATION, Göteborg (SE)

(72) Inventors: Rohan NEILSON, Västerås (SE); Pranav ARYA, Lindome (SE)

(73) Assignee: VOLVO TRUCK CORPORATION, Göteborg (SE)

(21) Appl. No.: 18/720,305

(22) PCT Filed: Dec. 15, 2021
(86) PCT No.: PCT/EP2021/085851

§ 371 Date: Jun. 14, 2024

(51) Int. Cl. H01M 8/04537; B60L 58/12; B60L 58/40; H01M 8/04089; H01M 8/04746

(52) U.S. Cl. CPC H01M 8/04604; B60L 58/12; B60L 58/40; H01M 8/04097; H01M 8/04753; B60L 2240/26; B60L 2240/64; B60L 2240/68; B60L 2260/52; H01M 2250/20

(57) ABSTRACT

The control unit is adapted to predict a future power requirement from the fuel cell system over a future time range and to issue information to the cathode recirculation arrangement in response to the predicted future power requirement. The information is indicative of whether the cathode recirculation arrangement should assume a condition so as to allow fluid communication between the cathode outlet and the cathode inlet or so as to prevent fluid communication between the cathode outlet and the cathode inlet.

### TECHNICAL FIELD

The invention relates to a control unit for a fuel cell system. Moreover, the present invention relates to a fuel cell system assembly. Additionally, the present invention relates to a power assembly. Furthermore, the present invention relates to a vehicle. Finally, the present invention relates to a method for controlling a fuel cell system.

The invention can be applied in heavy-duty vehicles, such as trucks, buses, cars and construction equipment. Although the invention will be described with respect to a truck, the invention is not restricted to this particular vehicle, but may also be used in other vehicles such as working machines, seagoing vessels or the like.

### BACKGROUND

A fuel cell system generally comprises and anode and a cathode. Moreover, a fuel cell system may comprise a cathode inlet and a cathode outlet as well as a e.g. an on/off valve controlling a feedback connection between the cathode outlet and the cathode inlet.

For instance, EP 1 427 046 B1 fuel cell system in accordance with the above wherein the above-mentioned on/off valve is open or closed in dependence on signals issued from moisture sensors.

However, the EP 1 427 046 B1 fuel cell system may still be improved in order to enhance the operability thereof.

### SUMMARY

An object of the invention is to provide a control unit for a fuel cell system which control unit can control a cathode recirculation arrangement of the fuel cell system in a manner that will result in an appropriate operation of the fuel cell system.

According to a first aspect of the invention, the object is achieved by a device according to claim 1.

As such, a first aspect of the invention relates to a control unit for a fuel cell system. The fuel cell system is adapted to produce electric power and comprising an anode and a cathode. The anode is adapted to receive fuel and the cathode being adapted to receive an oxidant. The fuel cell system comprises a cathode inlet, adapted to guide fluid comprising the oxidant towards the cathode, and a cathode outlet, adapted to guide fluid away from the cathode. The fuel cell system further comprises a cathode recirculation arrangement adapted to selectively allow or prevent fluid communication between the cathode outlet and the cathode inlet in response to information issued from the control unit. Purely by way of example, the cathode recirculation arrangement may be used for reducing the minimum possible power that can be output from the fuel cell system whilst keeping a cell voltage within a safe range.

According to the first aspect of the present invention, the control unit is adapted to predict a future power requirement from the fuel cell system over a future time range and to issue information to the cathode recirculation arrangement in response to the predicted future power requirement. The information is indicative of whether the cathode recirculation arrangement should assume a condition so as to allow fluid communication between the cathode outlet and the cathode inlet or so as to prevent fluid communication between the cathode outlet and the cathode inlet.

The control unit according to the first aspect of the present invention is thus adapted to issue signals to the cathode recirculation arrangement in response to a predicted future power requirement from the fuel cell system, i.e. the power that the fuel cell system is predicted to produce during the future time range. This in turn implies that the cathode recirculation arrangement may be controlled in a proactive manner which in turn may result in an appropriately high probability that the fuel cell system may be operational. Thus, in contrast to a reactive control strategy by which there is a risk that that the cathode recirculation arrangement may be operated using short cycles which for instance may result in fluctuations, oscillations or other undesired transient behaviours, the control unit according to the first aspect of the present invention implies that that the cathode recirculation arrangement may be operated in a more stable manner.

Optionally, the control unit is adapted to use a minimum output power closed communication value when issuing information to the cathode recirculation arrangement in response to the predicted future power requirement. The minimum output power closed communication value is indicative of the minimum power that can be produced by the fuel cell system when fluid communication between the cathode outlet and the cathode inlet is prevented and the fuel cell system is operating.

The minimum output power closed communication value may be useful information when determining the information indicative of whether the cathode recirculation arrangement should assume a condition so as to allow fluid communication between the cathode outlet and the cathode inlet or so as to prevent fluid communication between the cathode outlet and the cathode inlet.

The minimum output power open communication value is less than the minimum output power closed communication value and could even be net zero or negative depending on the recirculated fraction, i.e. the amount of fluid in the cathode outlet being recirculated to the cathode inlet. Purely by way of example, throttles located upstream and downstream of a compressor and turbine respectively may be used for targeting a low minimum output power open communication value.

Optionally, the control unit is adapted to determine an average future power requirement value, indicative of a predicted average future power requirement over a future time range. The control unit is adapted to issue the information in response to the average future power requirement value and the minimum output power closed communication value to thereby control the cathode recirculation arrangement during the future time range.

The use of the average future power requirement value implies that the cathode recirculation arrangement may be controlled with a reduced risk for rapid changes in the control of the cathode recirculation arrangement, as compared to a control based on an instantaneous power requirement for example.

Optionally, the control unit is adapted to issue the information such that, in response to detecting that the average future power requirement value is equal to or exceeds the minimum output power closed communication value, the information is indicative of that fluid communication between the cathode outlet and the cathode inlet is allowed for an aggregated fluid communication time range being smaller than the future time range, preferably the aggregated fluid communication time range is within the range of 0-50% of the future time range.

The inventors of the present invention have realised that in a situation such as the one presented hereinabove, there may be no need to allow fluid communication between the cathode outlet and the cathode inlet for a major portion of the future time range. As such, in scenarios falling within the above conditions, it may suffice to allow fluid communication between the cathode outlet and the cathode inlet for a limited time, such as future time instants or future time ranges for which a low future power requirement is expected.

Optionally, the control unit is adapted to issue the information such that, in response to detecting that the future time range comprises one or more instant time ranges within which the future power requirement is expected to be lower than the minimum output power closed communication value, the information is indicative of that fluid communication between the cathode outlet and the cathode inlet is allowed for the one or more instant time ranges. Preferably the information is indicative of that fluid communication between the cathode outlet and the cathode inlet is only allowed for the one or more instant time ranges.

Optionally, the control unit is adapted to use a minimum output power open communication value. The minimum output power open communication value is indicative of the minimum power that can be produced by the fuel cell system when fluid communication between the cathode outlet and the cathode inlet is allowed and the fuel cell system is operating.

The minimum output power open communication value may be useful when determining the information to be issued to the cathode recirculation arrangement.

Optionally, the control unit is adapted to issue the information such that, in response to detecting a reference time range of the least one of the one or more instant time ranges comprises a sub-range within which the future power requirement is expected to be lower than the minimum output power open communication value, the temporal extension of the reference time range is increased.

As such, upon detection of a sub-range in accordance with the above, the control unit may issue information such that the cathode recirculation arrangement assumes the condition so as to allow fluid communication between the cathode outlet and the cathode inlet for a longer time range than the sub-range. This in turn results in an appropriately high likelihood that the fuel cell system need not be shut off unnecessarily often, even in conditions in which the future power requirement is expected to be lower than the minimum output power open communication value from time to time.

Optionally, the control unit is adapted to issue the information such that, in response to detecting that the average future power requirement value is lower than the minimum output power closed communication value but exceeds the minimum output power open value, the information is indicative of that fluid communication between the cathode outlet and the cathode inlet is allowed for at least 90% of, preferably throughout, the future time range.

The inventors of the present invention have realized that it may be beneficial to allow fluid communication between the cathode outlet and the cathode inlet for a relatively large portion of, or even throughout, the future time range upon detecting that the average future power requirement value is between the limits presented hereinabove. As such, rather than switching between allowing and preventing fluid communication a plurality of times during the future time range, fluid communication may be allowed for a relatively long time which may result in an appropriately stable control of the fuel cell system.

Optionally, the control unit is adapted to, in response to detecting that the average future power requirement value is lower than the minimum output power open communication value, issue fuel cell system information indicative of that the fuel cell system should be shut down throughout the future time range.

When the average future power requirement value is below the above-mentioned limit, it may not be possible to operate the fuel cell system. As such, shutting down the fuel cell system may be an appropriate measure to take.

Optionally, the fuel cell system is adapted to contribute to the propulsion of a vehicle and wherein the control unit is adapted to receive vehicle related information indicative of at least one of the following for the future time range:
a traffic situation for an upcoming ground segment that the vehicle is predicted to be travelling on;
a terrain condition for an upcoming ground segment that the vehicle is predicted to be travelling on;
a topography of an upcoming ground segment that the vehicle is predicted to be travelling on;
a gross weight of vehicle;
ambient environmental conditions, such as speed and direction of wind;
health, history and/or condition of the fuel cell system, and
an estimated range of the vehicle and a distance to a refueling station
   and to use the vehicle related information when predicting the future power requirement from the fuel cell system.

One or more of the above pieces of information may result in that the average future power requirement value is determined in an appropriate manner.

Optionally, the fuel cell system is adapted to be connected to a battery and wherein the control unit is adapted to receive battery information indicative of at least one of the following for the future time range:
a current state of charge of the battery, and
an energy capacity of the battery,
   and to use the battery information when predicting the future power requirement from the fuel cell system.

The above information may for instance provide information indicative of whether or not it is possible to operate the fuel cell system in order to charge the battery. The future operation of the fuel cell system may be dependent on whether or not the battery can be charged. As such, information as regards the battery may be used in order to adequately predict the future power requirement from the fuel cell system.

Optionally, the future time range is at least 10 seconds, preferably at least 100 seconds, more preferred at least 300 seconds. However, it should be noted that in embodiments of the control unit of the invention, the future time range may be at least 1000 seconds.

A second aspect of the present invention relates to a fuel cell system assembly comprising a fuel cell system. The fuel cell system comprises an anode and a cathode, wherein the anode is adapted to receive fuel and the cathode is adapted to receive an oxidant. The fuel cell system comprises a cathode inlet, adapted to guide fluid comprising the oxidant towards the cathode, and a cathode outlet, adapted to guide fluid from the cathode. The fuel cell system further comprises a cathode recirculation arrangement adapted to selectively allow a fluid communication between the cathode outlet and the cathode inlet. The fuel cell system assembly further comprises a control unit according to the first aspect of the present invention. The control unit is adapted to issue information to at least the cathode recirculation arrangement.

Optionally, the cathode inlet comprises a cathode inlet conduit assembly and the cathode outlet comprises a cathode outlet conduit assembly. The cathode recirculation arrangement connects the cathode inlet conduit assembly to the cathode outlet conduit assembly.

Optionally, the fuel cell system comprises a turbo that in turn comprises a compressor forming part of the cathode inlet and a turbine forming part of the cathode outlet. The cathode recirculation arrangement connects a portion of the cathode inlet conduit assembly being located upstream the compressor to a portion of the cathode outlet conduit assembly being located upstream of the turbine, as seen in an intended direction of flow from the cathode inlet to the cathode outlet.

Optionally, the cathode recirculation arrangement comprises a cathode recirculation arrangement valve. The cathode recirculation arrangement valve is adapted to assume at least an open condition and a closed condition, respectively, in response to information issued from the control unit.

Optionally, the cathode recirculation arrangement valve is adapted to assume at least one intermediate condition between the open condition and the closed condition, preferably the cathode recirculation arrangement valve is adapted to assume a plurality of different intermediate conditions between the open condition and the closed condition.

Optionally, the control unit is adapted to issue fuel cell system information to the fuel cell system, the fuel cell system information comprising information whether or not the fuel cell system should be shut off.

A third aspect of the present invention relates to a power assembly comprising the fuel cell system assembly according to the second aspect of the present invention. The power assembly further comprises a battery. The fuel cell system is adapted to charge the battery at least during a charging condition of the power assembly.

A fourth aspect of the present invention relates to a vehicle comprising a fuel cell system assembly according to the second aspect of the present invention or a power assembly according to the third aspect of the present invention.

A fifth aspect of the present invention relates to a method for controlling a fuel cell system. The fuel cell system is adapted to produce electric power and comprising an anode and a cathode. The anode is adapted to receive fuel and the cathode is adapted to receive an oxidant. The fuel cell system comprises a cathode inlet, adapted to guide fluid comprising the oxidant towards the cathode, and a cathode outlet, adapted to guide fluid away from the cathode. The fuel cell system further comprises a cathode recirculation arrangement adapted to selectively allow a fluid communication between the cathode outlet and the cathode inlet.

According to the fifth aspect of the present invention, the method comprises predicting a future power requirement from the fuel cell system over a future time range and controlling the cathode recirculation arrangement in response to the prediction.

Optionally, the method comprises using a minimum output power closed communication value when issuing information to the cathode recirculation arrangement in response to the predicted future power requirement. The minimum output power closed communication value is indicative of the minimum power that can be produced by the fuel cell system when fluid communication between the cathode outlet and the cathode inlet is prevented and the fuel cell system is operating.

Optionally, the method comprises determining an average future power requirement value, indicative of a predicted average future power requirement over a future time range. The method further comprises issuing the information in response to the average future power requirement value and the minimum output power closed communication value to thereby control the cathode recirculation arrangement during the future time range.

Optionally, the method comprises issuing the information such that, in response to detecting that the average future power requirement value is equal to or exceeds the minimum output power closed communication value, the information is indicative of that fluid communication between the cathode outlet and the cathode inlet is allowed for an aggregated fluid communication time range being smaller than the future time range. Preferably the aggregated fluid communication time range is within the range of 0-50% of the future time range.

Optionally, the method comprises issuing the information such that, in response to detecting that the future time range comprises one or more instant time ranges within which the future power requirement is expected to be lower than the minimum output power closed communication value, the information is indicative of that fluid communication between the cathode outlet and the cathode inlet is allowed for the one or more instant time ranges. Preferably, the information is indicative of that fluid communication between the cathode outlet and the cathode inlet is only allowed for the one or more instant time ranges.

Optionally, the method comprises using a minimum output power open communication value, the minimum output power open communication value being indicative of the minimum power that can be produced by the fuel cell system when fluid communication between the cathode outlet and the cathode inlet is allowed and the fuel cell system is operating.

Optionally, the method comprises issuing the information such that, in response to detecting a reference time range of the least one of the one or more instant time ranges comprises a sub-range within which the future power requirement is expected to be lower than the minimum output power open communication value, the temporal extension of the reference time range is increased.

Optionally, the method comprises issuing the information such that, in response to detecting that the average future power requirement value is lower than the minimum output power closed communication value but exceeds the minimum output power open value, the information is indicative of that fluid communication between the cathode outlet and the cathode inlet is allowed for at least 90% of, preferably throughout, the future time range.

Optionally, the method comprises, in response to detecting that the average future power requirement value is lower than the minimum output power open communication value, issuing fuel cell system information indicative of that the fuel cell system should be shut down throughout the future time range.

Optionally, the fuel cell system is adapted to contribute to the propulsion of a vehicle and wherein the method comprises receiving vehicle related information indicative of at least one of the following for the future time range:
a traffic situation for an upcoming ground segment that the vehicle is predicted to be travelling on;
a terrain condition for an upcoming ground segment that the vehicle is predicted to be travelling on;
a topography of an upcoming ground segment that the vehicle is predicted to be travelling on;
a gross weight of vehicle;
ambient environmental conditions, such as speed and direction of wind;
health, history and/or condition of the fuel cell system, and
an estimated range of the vehicle and a distance to a refueling station
   and using the vehicle related information when predicting the future power requirement of said fuel cell system.

Optionally, the fuel cell system is adapted to be connected to a battery and wherein the method comprises receiving battery information indicative of at least one of the following for the future time range:
a current state of charge of the battery, and
an energy capacity of the battery,
   and using the battery information when predicting the future power requirement of said fuel cell system.

Optionally, the future time range is at least 10 seconds, preferably at least 100 seconds, more preferred at least 300 seconds. However, it should be noted that in embodiments of the method of the invention, the future time range may be at least 1000 seconds.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 schematically illustrates a vehicle;

FIG. 2 illustrates an embodiment of a power assembly;

FIG. 3 is a flow chart illustrating an embodiment of the control unit or the method of the present invention, and

FIGS. 4a-4d illustrate various scenarios for a future power requirement.

### DETAILED DESCRIPTION OF EXAMPLE EMBODIMENTS OF THE INVENTION

With reference to the appended drawings, below follows a more detailed description of embodiments of the invention cited as examples.

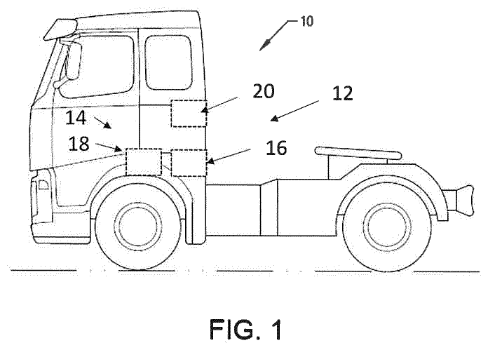

The invention will be described below for a vehicle in the form of a truck 10 such as the truck illustrated in FIG. 1. The truck 10 should be seen as an example of a vehicle which could comprise a control unit according to the present invention.

However, the present invention may be implemented in a plurality of different types of vehicles. Purely by way of example, the present invention could be implemented in a truck, a tractor, a car, a bus, a work machine such as a wheel loader or any other type of construction equipment. Moreover, the present invention need not be implanted in a vehicle but may be used for a stationary energy generating unit, such as a stationary fuel cell system (not shown).

The FIG. 1 vehicle 10 comprises a power assembly 12 comprising a fuel cell system assembly 14 and a battery 16. The fuel cell system assembly 14 comprises a fuel cell system 18 and a control unit 20 for controlling the fuel cell system 18. The fuel cell system 18 is adapted to charge the battery 16 at least during a charging condition of the power assembly 12. Other embodiments of the vehicle 10 may comprise more than one fuel cell system (not shown in FIG. 1).

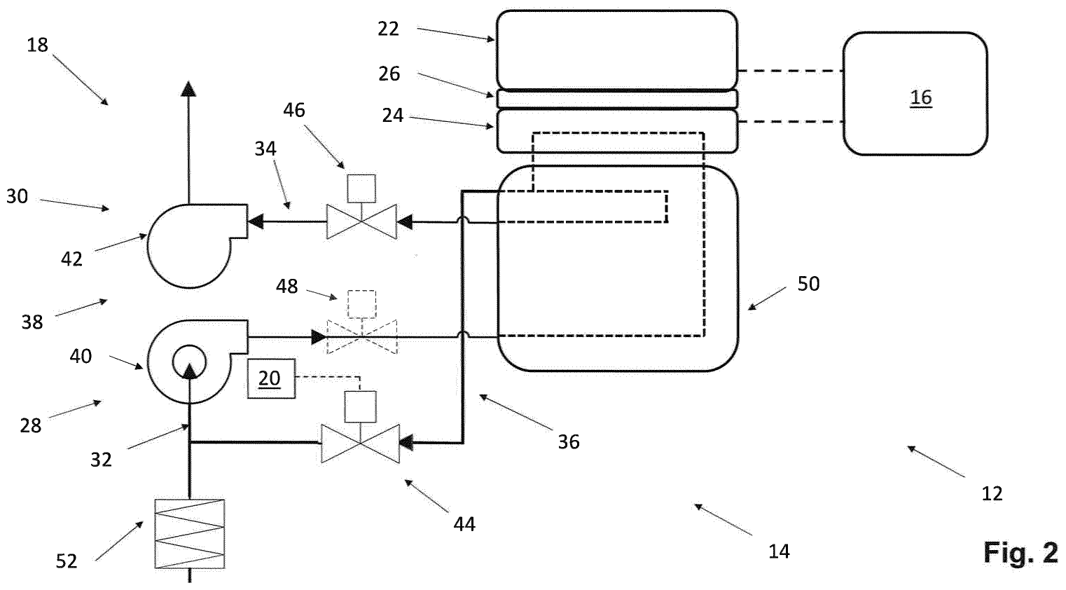

FIG. 2 schematically illustrates an embodiment of a power assembly 12. Purely by way of example, the FIG. 2 power assembly 12 may be used for a vehicle, such as the FIG. 1 truck 10.

The power assembly 12 comprises a fuel cell system assembly 14 and a battery 16, as has been indicated hereinabove. The fuel cell system assembly 14 comprises a fuel cell system 18 and a control unit 20. The control unit 20 is adapted to issue control information to the fuel cell system 18 as will be elaborated on further hereinbelow.

The fuel cell system is adapted to produce electric power and comprises an anode 22 and a cathode 24, wherein the anode 22 is adapted to receive fuel and the cathode 24 is adapted to receive an oxidant. Purely by way of example, the fuel may comprise hydrogen and the oxidant may comprise oxygen. Moreover, as indicated in FIG. 2, a membrane 26 may be located between the anode 22 and the cathode 24. As a non-limiting example, the membrane 26 may be such that it allows transport of protons, but prevents transport of electrons, from the anode 22 to the cathode 24. Because of the above prevention of electron transport through the membrane 26, electrons separated at the anode 22, which electrons for instance have been obtained by splitting hydrogen atoms into a proton and an electron, may be forwarded to a consumer of electric power, such as the battery 16 in FIG. 2.

Furthermore, again with reference to FIG. 2, the fuel cell system 18 comprises a cathode inlet 28, adapted to guide fluid comprising the oxidant towards the cathode 24, and a cathode outlet 30, adapted to guide fluid away from the cathode 24.

Furthermore, though purely by way of example, the cathode inlet 28 may comprise a cathode inlet conduit assembly 32, for instance comprising a plurality of different conduits, and the cathode outlet 30 may comprise a cathode outlet conduit assembly 34, which also may comprise a plurality of different conduits.

Moreover, as indicated in FIG. 2, the fuel cell system 18 comprises a cathode recirculation arrangement 36 adapted to selectively allow or prevent fluid communication between the cathode outlet 30 and the cathode inlet 28 in response to information issued from the control unit 20.

In the embodiment illustrated in FIG. 2, the cathode recirculation arrangement 36 connects the cathode inlet conduit assembly 32 to the cathode outlet conduit assembly 34.

Moreover, as exemplified in FIG. 2, the fuel cell system 18 may comprises a turbo 38 that in turn comprises a compressor 40 forming part of the cathode inlet 28 and a turbine 42 forming part of the cathode outlet 30. Purely by way of example, and as indicated in FIG. 2, the cathode recirculation arrangement 36 may connect a portion of the cathode inlet conduit assembly 32 being located upstream the compressor 40 to a portion of the cathode outlet conduit assembly 34 being located upstream of the turbine 42, as seen in an intended direction of flow from the cathode inlet 28 to the cathode outlet 30. However, it is envisaged that the cathode recirculation arrangement 36 may be connecting other portions of the cathode outlet 30 and the cathode inlet 28 in other embodiments of the fuel cell system 18.

As a non-limiting example, the cathode recirculation arrangement 36 may comprise a cathode recirculation arrangement valve 44. The cathode recirculation arrangement valve 44 may be adapted to assume at least an open condition and a closed condition, respectively, in response to information issued from the control unit 20.

As a first example, the cathode recirculation arrangement valve 44 may be an on/off valve. However, as another non-limiting example, the cathode recirculation arrangement valve 44 may be adapted to assume at least one intermediate condition between the open condition and the closed condition. Preferably, the cathode recirculation arrangement valve 44 may be adapted to assume a plurality of different intermediate conditions between the open condition and the closed condition. As a non-limiting example, the cathode recirculation arrangement valve 44 may be adapted to be continuously controlled from the open condition to the closed condition such that the cathode recirculation arrangement valve 44 can assume an infinite number of conditions between the from the open condition to the closed condition. As another non-limiting example, the cathode recirculation arrangement valve 44 may be adapted to be controlled from the open condition to the closed condition in a stepwise manner.

Irrespective of the implementation of the cathode recirculation arrangement 36, it Is generally such that the condition of the cathode recirculation arrangement 36 may have an influence of the minimum output power available from the fuel cell system 18.

As such, when fluid communication between the cathode outlet 30 and the cathode inlet 28 is prevented and the fuel cell system 18 is operating, the fuel cell system 18 can produce a minimum output power that corresponds to a minimum output power closed communication value. In a similar vein, when fluid communication between the cathode outlet 30 and the cathode inlet 28 is allowed and the fuel cell system 18 is operating, the fuel cell system 18 can produce a minimum output power that corresponds to a minimum output power open communication value. Generally, the minimum output power open communication value is smaller than the minimum output power close communication value, indicating that the minimum output power producible when fluid communication between the cathode outlet 30 and the cathode inlet 28 is allowed is smaller than the minimum output power producible when fluid communication between the cathode outlet 30 and the cathode inlet 28 is prevented.

Moreover, though purely by way of example, the cathode outlet conduit assembly 34 may comprise a valve 46, such as a backpressure valve 46 upstream the turbine 42. Furthermore, again as a non-limiting example, the cathode inlet conduit assembly 32 may comprise a sealing valve 48, for instance downstream the compressor 40. Purely by way of example, the sealing valve 48 may operate in response to information received from the control unit 20.

In the FIG. 2 embodiment, the fuel cell system comprises a humidifier 50. Furthermore, again with reference to FIG. 2, at least a portion of the cathode inlet conduit assembly 32 located downstream the cathode 24 may extend through the humidifier 50. In a similar manner, although again purely by way of example, at least a portion of the cathode outlet conduit assembly 34 located upstream the cathode 24 may extend through the humidifier 50.

As a further non-limiting example, the in the FIG. 2 embodiment, the cathode inlet 28 comprises an intake filter 52. Such an intake filter may be located downstream the compressor 40 in implementations of the cathode inlet 28 comprising a compressor 40.

A first aspect of the invention relates to the control unit 20 for a fuel cell system 18. As has been intimated hereinabove, the fuel cell system 18 is adapted to produce electric power. Moreover, the fuel cell system 18 comprises an anode 22 and a cathode 24. The anode 22 is adapted to receive fuel and the cathode 24 is adapted to receive an oxidant. The fuel cell system comprises a cathode inlet 28, adapted to guide fluid comprising the oxidant towards the cathode 24, and a cathode outlet 30, adapted to guide fluid away from the cathode 24. The fuel cell system further comprises a cathode recirculation arrangement 36 adapted to selectively allow or prevent fluid communication between the cathode outlet 30 and the cathode inlet 28 in response to information issued from the control unit.

Moreover, according to the first aspect of the present invention, the control unit 20 is adapted to predict a future power requirement from the fuel cell system 18 over a future time range and to issue information to the cathode recirculation arrangement 36 in response to the predicted future power requirement.

The information is indicative of whether the cathode recirculation arrangement 36 should assume a condition so as to allow fluid communication between the cathode outlet and the cathode inlet or so as to prevent fluid communication between the cathode outlet and the cathode inlet. As such, as a non-limiting example with reference to the FIG. 2 embodiment, the control unit 20 may be adapted to issue information to the cathode recirculation arrangement valve 44 indicative of whether the cathode recirculation arrangement valve 44 should assume an open condition, a closed condition or possibly an intermediate condition between the open condition and the closed condition.

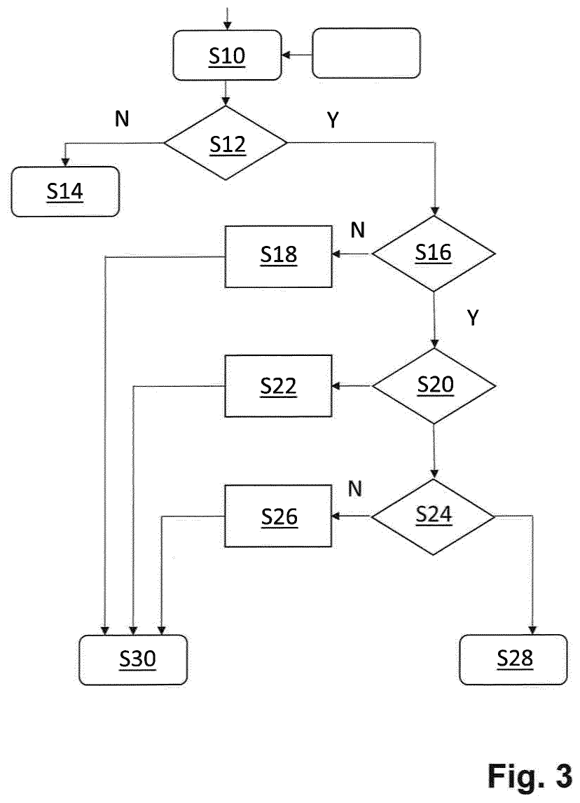

FIG. 3 illustrates a flowchart presenting how a control unit 20 according to an embodiment of the present invention is intended to operate. For the sake of completeness, the FIG. 3 flow chart may be equally applicable to the method of the present invention.

Furthermore, for the sake of completeness, it should be noted that FIG. 3 flowchart merely serves as an example of how the control unit 20 may operate and/or how the method according to the invention can be carried out. It is of course envisaged that embodiments of the control unit 20 or the method may comprise fewer steps than what is presented hereinbelow with reference to FIG. 3. Moreover, it is also envisaged that embodiments of the control unit 20 or the method may perform steps in an order different from the order discussed hereinbelow with reference to FIG. 3.

A first step S10 in FIG. 3 relates to a prediction of a future power requirement P(t) from the fuel cell system 18 over a future time range Δt. Purely by way of example, the future time range Δt may be at least 10 seconds, preferably at least 100 seconds, more preferred at least 300 seconds. As indicated by the expression P(t), the future power requirement may be presented as a function of time.

To this end, and as indicated in FIG. 3, the step S10 may comprise receiving information from other information sources. Purely by way of examples, such information sources may comprise one or more sensors.

In embodiments of the present invention in which the fuel cell system 18 is adapted to contribute to the propulsion of a vehicle, such as the FIG. 1 vehicle, the control unit 20 may be adapted to receive vehicle related information indicative of at least one of the following for the future time range Δt:
a traffic situation for an upcoming ground segment that the vehicle is predicted to be travelling on; the traffic situation may also include information indicative of if/when the vehicle is expected to be stopped, such as at loading terminals, ferry terminals and the like, and as another alternative, the traffic situation may comprise information indicative of a potentially polluting environmental conditions such as traffic congestion, tunnels, fires, etcetera;
a terrain condition for an upcoming ground segment that the vehicle is predicted to be travelling on;
a topography of an upcoming ground segment that the vehicle is predicted to be travelling on;
a gross weight of vehicle;
ambient environmental conditions, such as speed and direction of wind;
health, history and/or condition of the fuel cell system, and
an estimated range of the vehicle and a distance to a refueling station
   and to use the vehicle related information when predicting the future power requirement P(t) from the fuel cell system 18.

Instead of, or in addition to, using any one of the above, in embodiments in which the fuel cell system 18 is adapted to be connected to a battery 16 and wherein the control unit 20 is adapted to receive battery information indicative of at least one of the following for the future time range Δt:
a current state of charge of the battery, and
an energy capacity of the battery,
   and to use the battery information when predicting the future power requirement P(t) from the fuel cell system 18.

Irrespective of how the future power requirement P(t) from the fuel cell system 18 over a future time range Δt is predicted, the thus determined future power requirement P(t) is used for controlling e.g. the cathode recirculation arrangement 36.

Purely by way of example, the control unit 20 or the method of the present invention may use a minimum output power closed communication value P_{min,c} when issuing information to the cathode recirculation arrangement 36 in response to the predicted future power requirement P(t). As has been mentioned hereinabove with reference to FIG. 2, the minimum output power closed communication value P_{min,c} is indicative of the minimum power that can be produced by the fuel cell system 18 when fluid communication between the cathode outlet 30 and the cathode inlet 28 is prevented and the fuel cell system 18 is operating.

Purely by way of example, the control unit 20 or method of the invention may comprise a step S12 of assessing if there is any instant time range in the future time range Δt at which the future power requirement P(t) is expected to be lower than the minimum output power closed communication value P_{min,c}.

If no such instant time range can be identified (see letter N to the left of step S12 in FIG. 3), the control unit 20 or method of the invention may proceed to a step S14 which may relate to a normal operation of the fuel cell system 18, viz operating the fuel cell system 18 without operating the cathode recirculation arrangement 36 and by preventing fluid communication between the cathode outlet 30 and the cathode inlet 28.

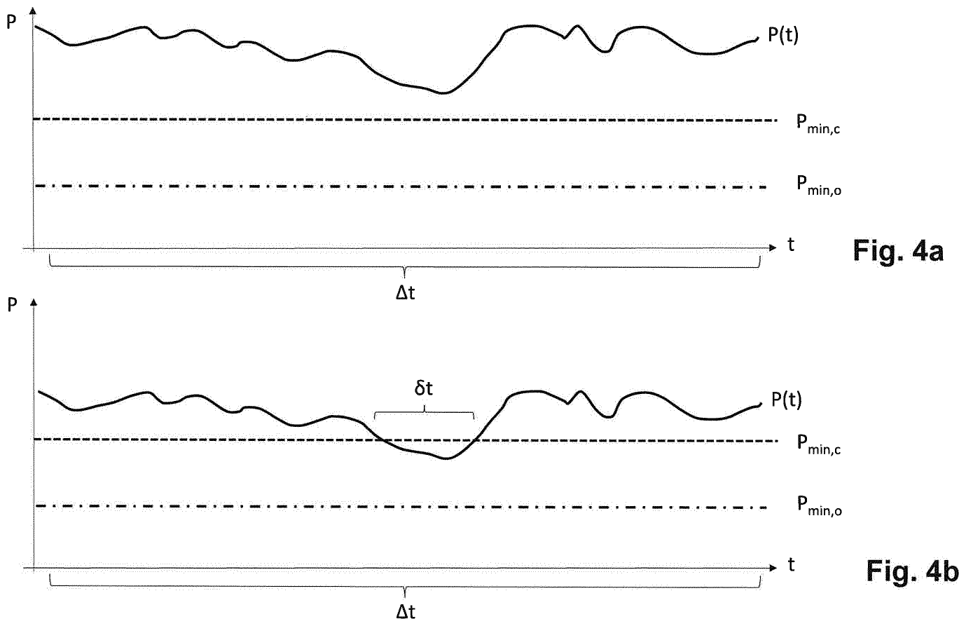

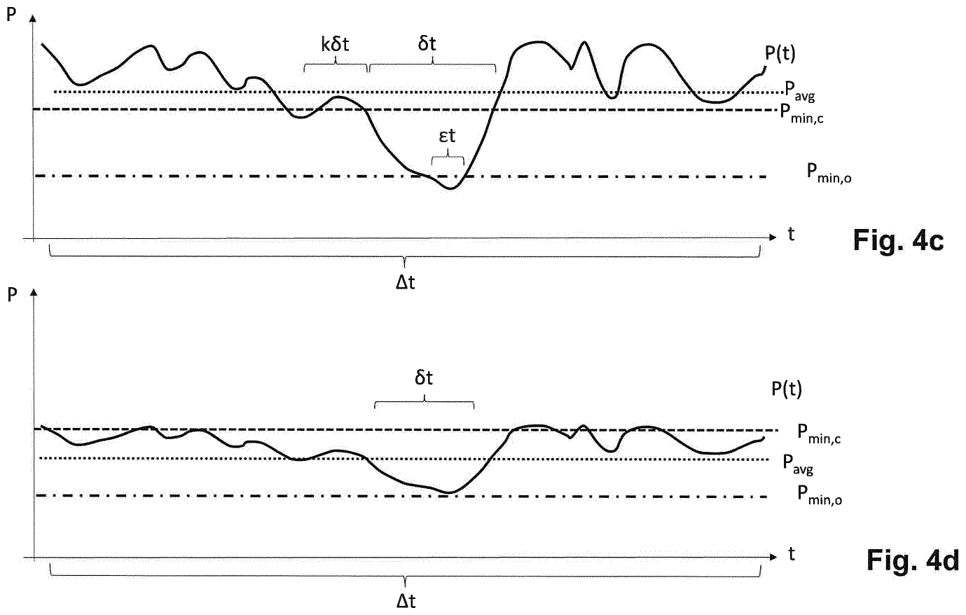

A future power requirement P(t) scenario in which no instant time range can be identified in the future time range Δt at which the future power requirement P(t) is expected to be lower than the minimum output power closed communication value P_{min,c} is illustrated in FIG. 4a. As may be gleaned from FIG. 4a, the future power requirement P(t) is consistently above the minimum output power closed communication value P_{min,c} throughout the future time range Δt.

If at least one such instant time range can be identified (see letter Y to the right of step S12 in FIG. 3), the control unit 20 or method of the invention may proceed to a step S16 which may comprise a step of assessing if there is any instant time range in the future time range Δt at which the future power requirement P(t) is expected to be lower than a minimum output power open communication value P_{min,o}. The minimum output power open communication value P_{min,o} is indicative of the minimum power that can be produced by the fuel cell system 18 when fluid communication between the cathode outlet 30 and the cathode inlet 28 is allowed and the fuel cell system 18 is operating.

If no such instant time range can be identified (see letter N to the left of step S16 in FIG. 3), the control unit 20 or method of the invention may proceed to a step S18. The aggregation of information from steps S12 and S16 results in that the future power requirement P(t) is expected to be lower than the minimum output power closed communication value P_{min,c} for at least one instant time range for the future time range Δt but that the future power requirement P(t) is not expected to be lower than the minimum output power open communication value P_{min,o} at any instant time range for the future time range Δt.

As such, step S18 may comprise that the control unit 20 or the method of the present invention issues the information such that, in response to detecting that the future time range Δt comprises one or more instant time ranges within which the future power requirement is expected to be lower than the minimum output power closed communication value P_{min,c}, the information is indicative of that fluid communication between the cathode outlet 30 and the cathode inlet 28 is allowed for the one or more instant time ranges. Preferably the information is indicative of that fluid communication between the cathode outlet 30 and the cathode inlet 28 is only allowed for the one or more instant time ranges.

A future power requirement P(t) comprising an instant time range δt within which the future power requirement is expected to be lower than the minimum output power closed communication value P_{min,c} but higher than the minimum output power open communication value P_{min,o} is illustrated in FIG. 4b. As such, in the FIG. 4b scenario, the control unit 20 or the method of the present invention issues the information such that fluid communication between the cathode outlet 30 and the cathode inlet 28 is allowed for the instant time range δt.

If there is at least one instant time range in the future time range Δt at which the future power requirement P(t) is expected to be lower than a minimum output power open communication value P_{min,o}, see the letter Y below step S16 in FIG. 3, the control unit 20 or method of the invention may proceed to a step S20.

In step S20, the control unit 20 or the method of the present invention may determine an average future power requirement value P_{avg}, indicative of a predicted average future power requirement over a future time range Δt.

The control unit 20 or the method of the present invention is adapted to issue the information in response to the average future power requirement value P_{avg} and the minimum output power closed communication value P_{min,c} to thereby control the cathode recirculation arrangement during the future time range.

Purely by way of example, step S20 may comprise comparing the average future power requirement value P_{avg} to the minimum output power closed communication value P_{min,c}. If the control unit 20 or the method of the present invention detects that the average future power requirement value P_{avg} is equal to or exceeds the minimum output power closed communication value P_{min,c}, the control unit 20 or the method of the present invention may be adapted to issue the information such that the information is indicative of that fluid communication between the cathode outlet 30 and the cathode inlet 28 is allowed for an aggregated fluid communication time range being smaller than the future time range Δt. Purely by way of example, the aggregated fluid communication time range is within the range of 0-50% of the future time range.

An embodiment of the above embodiment is exemplified by step S22 in FIG. 3 as well as the condition in FIG. 4c. As may be gleaned from FIG. 4c, the average future power requirement value P_{avg} exceeds the minimum output power closed communication value P_{min,c} for the future time range Δt. As such, in the FIG. 4c condition, the control unit 20 or the method of the present invention may issue information indicative of that fluid communication between the cathode outlet 30 and the cathode inlet 28 is allowed for an aggregated fluid communication time range being smaller than the future time range Δt.

Moreover, though purely by way of example, the control unit 20 or the method of the present invention may be adapted to issue the information such that, in response to detecting that the future time range Δt comprises one or more instant time ranges δt within which the future power requirement is expected to be lower than the minimum output power closed communication value P_{min,c}, the information is indicative of that fluid communication between the cathode outlet 30 and the cathode inlet 28 is allowed for the one or more instant time ranges δt.

Additionally, the control unit 20 or the method of the present invention may be adapted to use a minimum output power open communication value P_{min,o}, see e.g. FIG. 4c. As has been discussed hereinabove with reference to FIG. 2, the minimum output power open communication value P_{min,o} is indicative of the minimum power that can be produced by the fuel cell system 18 when fluid communication between the cathode outlet 30 and the cathode inlet 28 is allowed and the fuel cell system 18 is operating.

Furthermore, the control unit 20 or the method of the present invention may be adapted to issue the information such that, in response to detecting a reference time range δt of the least one of the one or more instant time ranges comprises a sub-range εt within which the future power requirement is expected to be lower than the minimum output power open communication value P_{min,o}, the temporal extension of the reference time range δt is increased.

An example of an embodiment in accordance with the above is presented with reference to FIG. 4c. In a similar manner as for FIG. 4b, the FIG. 4c condition contains an instant time range δt within which the future power requirement is expected to be lower than the minimum output power closed communication value P_{min,c}. However, in contrast to the FIG. 4b scenario, the FIG. 4c instant time range δt comprises a sub-range εt within which the future power requirement is expected to be lower than the minimum output power open communication value P_{min,o}.

The detection of the above-mentioned sub-range εt be used for increasing the reference time range δt, vis the instant time range of which the sub-range εt forms part. As such, the information issued from the control unit 20 or the method may result in that fluid communication between the cathode outlet 30 and the cathode inlet 28 is allowed for an actual time range that is greater than the instant time range δt. Purely by way of example, the increase of the instant time range δt may be dependent on the temporal extension of the sub-range εt. However, though purely by way of example, the temporal extension of the reference time range δt may be increased by at least 20%, preferably at least 40%, upon detecting a sub-range εt within which the future power requirement is expected to be lower than the minimum output power open communication value P_{min,o}. As a non-limiting example, the increase of the reference time range δt may be added before the start of the original reference time range δt. Such an example is illustrated in FIG. 4c wherein an additional time range kδt is added before the reference time range δt.

Moreover, the control unit 20 or the method of the present invention may be adapted to issue the information such that, in response to detecting that the average future power requirement value P_{avg} is lower than the minimum output power closed communication value P_{min,c} but exceeds the minimum output power open value P_{min,o}, the information is indicative of that fluid communication between the cathode outlet 30 and the cathode inlet 28 is allowed for at least 90% of, preferably throughout, the future time range Δt.

An example of the above embodiment is exemplified by steps S24 and S26 in FIG. 3 as well as FIG. 4d. FIG. 4d illustrates a scenario when the average future power requirement value P_{avg} is lower than the minimum output power closed communication value P_{min,c} but exceeds the minimum output power open value P_{min,o}. Thus, the FIG. 3 step S24 may comprise determining whether or not the average future power requirement value P_{avg} is lower than the minimum output power open communication value P_{min,o}. If it is concluded in step S24 that the average future power requirement value P_{avg} is not smaller than the minimum output power open communication value P_{min,o}, (see letter N to the left of step S24 in FIG. 3), the control unit 20 or the method according to the present invention may proceed to step 26 which may comprise sending information in response to detecting that the average future power requirement value P_{avg} is lower than the minimum output power closed communication value P_{min,c} but exceeds the minimum output power open value P_{min,o}.

As such, in the FIG. 4d scenario, the control unit 20 or the method of the present invention may issue information indicative of that fluid communication between the cathode outlet 30 and the cathode inlet 28 should be allowed for at least 90% of, preferably throughout, the future time range Δt. As such, though purely by way of example, upon detecting that P_{min,o}<P_{avg}<P_{min,c}, fluid communication between the cathode outlet 30 and the cathode inlet 28 may be allowed throughout the future time range Δt.

As may be realized from the above each one of the steps S18, S22 and S26 in the FIG. 3 flow chart may result in that the cathode recirculation arrangement 36 assumes a condition so as to allow fluid communication between the cathode outlet 30 and the cathode inlet 28 for at least a portion of the future time range Δt.

Finally, if it is concluded in step S24 that the average future power requirement value P_{avg} is smaller than the minimum output power open communication value P_{min,o}, (see letter Y to below step S24 in FIG. 3), the control unit 20 or the method according the control unit 20 or the method may be such that it is adapted to, in response to detecting that the average future power requirement value P_{avg} is lower than the minimum output power open communication value P_{min,o}, issue fuel cell system information indicative of that the fuel cell system 18 should be shut down throughout the future time range Δt.

When the average future power requirement value is below the above-mentioned limit, it may not be possible to operate the fuel cell system. As such, shutting down the fuel cell system may be an appropriate measure to take.

Further advantages and advantageous features of the invention are disclosed in the following description and in the dependent claims. It is to be understood that the present invention is not limited to the embodiments described above and illustrated in the drawings; rather, the skilled person will recognize that many changes and modifications may be made within the scope of the appended claims.

Purely by way of example, although the FIG. 3 flowchart has been used for presenting various implementations of the control unit 20 or the method of the present invention, it should be noted that embodiments of the present invention may comprise more or fewer steps than what have been discussed hereinabove with reference to FIG. 3.

1. A control unit for a fuel cell system, said fuel cell system being adapted to produce electric power and comprising an anode and a cathode, said anode being adapted to receive fuel and said cathode being adapted to receive an oxidant, said fuel cell system comprising a cathode inlet, adapted to guide fluid comprising said oxidant towards said cathode, and a cathode outlet, adapted to guide fluid away from said cathode, said fuel cell system further comprising a cathode recirculation arrangement adapted to selectively allow or prevent fluid communication between said cathode outlet and said cathode inlet in response to information issued from said control unit, wherein said control unit is adapted to predict a future power requirement from said fuel cell system over a future time range and to issue information to said cathode recirculation arrangement in response to said predicted future power requirement, said information being indicative of whether said cathode recirculation arrangement should assume a condition so as to allow fluid communication between said cathode outlet and said cathode inlet or so as to prevent fluid communication between said cathode outlet and said cathode inlet.

2. The control unit according to claim 1, wherein said control unit is adapted to use a minimum output power closed communication value when issuing information to said cathode recirculation arrangement in response to said predicted future power requirement, said minimum output power closed communication value being indicative of the minimum power that can be produced by said fuel cell system when fluid communication between said cathode outlet and said cathode inlet is prevented and the fuel cell system is operating.

3. The control unit according to claim 2, wherein said control unit is adapted to determine an average future power requirement value, indicative of a predicted average future power requirement over a future time range, said control unit being adapted to issue said information in response to said average future power requirement value and said minimum output power closed communication value to thereby control said cathode recirculation arrangement during said future time range.

4. The control unit according to claim 3, wherein said control unit is adapted to issue said information such that, in response to detecting that said average future power requirement value is equal to or exceeds said minimum output power closed communication value, said information is indicative of that fluid communication between said cathode outlet and said cathode inlet is allowed for an aggregated fluid communication time range being smaller than said future time range.

5. The control unit according to claim 2, wherein said control unit is adapted to issue said information such that, in response to detecting that said future time range comprises one or more instant time ranges within which said future power requirement is expected to be lower than said minimum output power closed communication value, said information is indicative of that fluid communication between said cathode outlet and said cathode inlet is allowed for said one or more instant time ranges, said information is indicative of that fluid communication between said cathode outlet and said cathode inlet is only allowed for said one or more instant time ranges.

6. The control unit according to claim 2, wherein said control unit is adapted to use a minimum output power open communication value, said minimum output power open communication value being indicative of the minimum power that can be produced by said fuel cell system when fluid communication between said cathode outlet and said cathode inlet is allowed and the fuel cell system is operating.

7. The control unit according to claim 6, wherein said control unit is adapted to issue said information such that, in response to detecting a reference time range of said least one of said one or more instant time ranges comprises a sub-range within which said future power requirement is expected to be lower than said minimum output power open communication value, the temporal extension of said reference time range is increased.

8. The control unit according to claim 6, wherein said control unit is adapted to issue said information such that, in response to detecting that said average future power requirement value is lower than said minimum output power closed communication value but exceeds said minimum output power open value, said information is indicative of that fluid communication between said cathode outlet and said cathode inlet is allowed for at least 90% of said future time range.

9. The control unit according to claim 6, wherein said control unit is adapted to, in response to detecting that said average future power requirement value is lower than said minimum output power open communication value, issue fuel cell system information indicative of that the fuel cell system should be shut down throughout said future time range.

10. The control unit according to claim 1, wherein said fuel cell system is adapted to contribute to the propulsion of a vehicle and wherein said control unit is adapted to receive vehicle related information indicative of at least one of the following for said future time range:
a traffic situation for an upcoming ground segment that the vehicle is predicted to be travelling on;
a terrain condition for an upcoming ground segment that the vehicle is predicted to be travelling on;
a topography of an upcoming ground segment that the vehicle is predicted to be travelling on;
a gross weight of vehicle;
ambient environmental conditions, such as speed and direction of wind;
health, history and/or condition of the fuel cell system, and
an estimated range of said vehicle and a distance to a refueling station
and to use the vehicle related information when predicting said future power requirement from said fuel cell system.

11. The control unit according to claim 1, wherein said fuel cell system is adapted to be connected to a battery and wherein said control unit is adapted to receive battery information indicative of at least one of the following for said future time range:
a current state of charge of the battery, and
an energy capacity of said battery,
and to use the battery information when predicting said future power requirement from said fuel cell system.

12. The control unit according to claim 1, wherein said future time range is at least 10 seconds.

13. A fuel cell system assembly comprising a fuel cell system, said fuel cell system comprising an anode and a cathode, wherein said anode is adapted to receive fuel and said cathode is adapted to receive an oxidant, said fuel cell system comprising a cathode inlet, adapted to guide fluid comprising said oxidant towards said cathode, and a cathode outlet, adapted to guide fluid away from said cathode, said fuel cell system further comprising a cathode recirculation arrangement adapted to selectively allow a fluid communication between said cathode outlet and said cathode inlet, said fuel cell system assembly further comprises a control unit according to claim 1, said control unit being adapted to issue information to at least said cathode recirculation arrangement.

14. The fuel cell system assembly according to claim 13, wherein said cathode inlet comprises a cathode inlet conduit assembly and said cathode outlet comprises a cathode outlet conduit assembly, said cathode recirculation arrangement connecting said cathode inlet conduit assembly to said cathode outlet conduit assembly.

15. The fuel cell system assembly according to claim 14, wherein said fuel cell system comprises a turbo that in turn comprises a compressor forming part of said cathode inlet and a turbine forming part of said cathode outlet, said cathode recirculation arrangement connecting a portion of said cathode inlet conduit assembly being located upstream said compressor to a portion of said cathode outlet conduit assembly being located upstream of said turbine, as seen in an intended direction of flow from said cathode inlet to said cathode outlet.

16. The fuel cell system assembly according to claim 13, wherein said cathode recirculation arrangement comprises a cathode recirculation arrangement valve, said cathode recirculation arrangement valve being adapted to assume at least an open condition and a closed condition, respectively, in response to information issued from said control unit.

17. The fuel cell system assembly according to claim 16, wherein said cathode recirculation arrangement valve is adapted to assume at least one intermediate condition between said open condition and said closed condition, preferably said cathode recirculation arrangement valve is adapted to assume a plurality of different intermediate conditions between said open condition and said closed condition.

18. The fuel cell system assembly according to claim 13, wherein said control unit is adapted to issue fuel cell system information to said fuel cell system, said fuel cell system information comprising information whether or not said fuel cell system should be shut off.

19. A power assembly comprising the fuel cell system assembly according to claim 13, wherein said power assembly further comprises a battery, said fuel cell system being adapted to charge said battery at least during a charging condition of said power assembly.

20. A vehicle comprising a fuel cell system assembly according to claim 13.

21. A method for controlling a fuel cell system, said fuel cell system being adapted to produce electric power and comprising an anode and a cathode, said anode being adapted to receive fuel and said cathode being adapted to receive an oxidant, said fuel cell system comprising a cathode inlet, adapted to guide fluid comprising said oxidant towards said cathode, and a cathode outlet, adapted to guide fluid away from said cathode, said fuel cell system further comprising a cathode recirculation arrangement adapted to selectively allow a fluid communication between said cathode outlet and said cathode inlet, comprising predicting a future power requirement from said fuel cell system over a future time range and controlling said cathode recirculation arrangement in response to said prediction.

22. The method according to claim 21, wherein said method comprises using a minimum output power closed communication value when issuing information to said cathode recirculation arrangement in response to said predicted future power requirement, said minimum output power closed communication value being indicative of the minimum power that can be produced by said fuel cell system when fluid communication between said cathode outlet and said cathode inlet is prevented and the fuel cell system is operating.

23. The method according to claim 22, wherein said method comprises determining an average future power requirement value, indicative of a predicted average future power requirement over a future time range, said method further comprising issuing said information in response to said average future power requirement value and said minimum output power closed communication value to thereby control said cathode recirculation arrangement during said future time range.

24. The method according to claim 23, wherein said method comprises issuing said information such that, in response to detecting that said average future power requirement value is equal to or exceeds said minimum output power closed communication value, said information is indicative of that fluid communication between said cathode outlet and said cathode inlet is allowed for an aggregated fluid communication time range being smaller than said future time range, preferably the aggregated fluid communication time range is within the range of 0-50% of said future time range.

25. The method according to claim 22, wherein said method comprises issuing said information such that, in response to detecting that said future time range comprises one or more instant time ranges within which said future power requirement is expected to be lower than said minimum output power closed communication value, said information is indicative of that fluid communication between said cathode outlet and said cathode inlet is allowed for said one or more instant time ranges, preferably said information is indicative of that fluid communication between said cathode outlet and said cathode inlet is only allowed for said one or more instant time ranges.

26. The method according to claim 22, wherein said method comprises using a minimum output power open communication value, said minimum output power open communication value being indicative of the minimum power that can be produced by said fuel cell system when fluid communication between said cathode outlet and said cathode inlet is allowed and the fuel cell system is operating.

27. The method according to claim 26, wherein said method comprises issuing said information such that, in response to detecting a reference time range of said least one of said one or more instant time ranges comprises a sub-range within which said future power requirement is expected to be lower than said minimum output power open communication value, the temporal extension of said reference time range is increased.

28. The method according to claim 26, wherein said method comprises issuing said information such that, in response to detecting that said average future power requirement value is lower than said minimum output power closed communication value but exceeds said minimum output power open value, said information is indicative of that fluid communication between said cathode outlet and said cathode inlet is allowed for at least 90% of said future time range.

29. The method according to claim 26, wherein said method comprises, in response to detecting that said average future power requirement value is lower than said minimum output power open communication value, issuing fuel cell system information indicative of that the fuel cell system should be shut down throughout said future time range.

30. The method according to claim 21, wherein said fuel cell system is adapted to contribute to the propulsion of a vehicle and wherein said method comprises receiving vehicle related information indicative of at least one of the following for said future time range:
a traffic situation for an upcoming ground segment that the vehicle is predicted to be travelling on;
a terrain condition for an upcoming ground segment that the vehicle is predicted to be travelling on;
a topography of an upcoming ground segment that the vehicle is predicted to be travelling on;
a gross weight of vehicle;
ambient environmental conditions, such as speed and direction of wind;
health, history and/or condition of the fuel cell system, and
an estimated range of said vehicle and a distance to a refueling station
and using the vehicle related information when predicting said future power requirement from said fuel cell system.

31. The method according to claim 21, wherein said fuel cell system is adapted to be connected to a battery and wherein said method comprises receiving battery information indicative of at least one of the following for said future time range:
a current state of charge of the battery, and
an energy capacity of said battery,
and using the battery information when predicting said future power requirement from said fuel cell system.

32. The method according to claim 21, wherein said future time range is at least 10 seconds.
